(19) United States
(12) Patent Application Publication
(10) Pub. No.: US 2017/0075705 A1
(43) Pub. Date: Mar. 16, 2017

(54) OPTIMIZING COMPUTER SYSTEMS BY ADJUSTING COMPUTER RESOURCE USAGE

(71) Applicant: INTERNATIONAL BUSINESS MACHINES CORPORATION, Armonk, NY (US)

(72) Inventor: CRAIG A. FARRELL, SAN DIEGO, CA (US)

(21) Appl. No.: 14/854,201

(22) Filed: Sep. 15, 2015

(51) Int. Cl. G06F 9/445; G06F 11/34; G06F 11/30; G06F 9/50

(52) U.S. Cl. CPC G06F 9/44505; G06F 9/5011; G06F 11/3409; G06F 11/3024

(57) ABSTRACT

A computer-implemented method, system, and/or computer program product optimizes a computer system. One or more processors receive metrics from sensors in the computer system. The metrics describe usage levels of computer resources by the computer system. The processor(s) retrieve a complaint to loss (CTL) ratio of users of the computer system. The CTL ratio describes a ratio of complaints about the computer system by a set of users to a quantity of users from the set of users who discontinue using the computer system. In response to the CTL ratio falling outside of a predefined range, the processor(s) adjust a configuration of the computer system, such that adjusting the configuration of the computer system modifies the usage levels of the computer resources by the computer system.

### BACKGROUND

The present disclosure relates to the field of computer resources, and specifically to computer resources used by a computer system. Still more specifically, the present disclosure relates to the field of optimizing and managing computer systems by adjusting usage of the computer resources.

### SUMMARY

A computer-implemented method, system, and/or computer program product optimizes a computer system. One or more processors receive metrics from sensors in the computer system. The metrics describe usage levels of computer resources by the computer system. The processor(s) retrieve a complaint to loss (CTL) ratio from users of the computer system. The CTL ratio describes a ratio of complaints about the computer system by a set of users to a quantity of users from the set of users who discontinue using the computer system. In response to the CTL ratio falling outside of a predefined range, the processor(s) adjust a configuration of the computer system, such that adjusting the configuration of the computer system modifies the usage levels of the computer resources by the computer system.

### BRIEF DESCRIPTION OF THE DRAWINGS

FIG. 1 depicts an exemplary system and network in which the present disclosure may be implemented;

FIG. 2 illustrates a two dimensional Cartesian graph having a first axis (X-axis) that depicts the quantity of lost users of a computer system and a second axis (Y-axis) that depicts the quantity of complaints about the computer system in a complaint-to-loss (CTL) ratio;

FIG. 3 depicts alternative one-dimensional CTL-based graphs of complaints and loss of users of a computer system;

FIG. 4 depicts a sensor monitoring usage of resources by a computer system;

FIG. 5 is a high-level flow chart of one or more steps performed by one or more processors to optimize a computer system in accordance with one or more embodiments of the present invention;

FIG. 6 depicts a cloud computing node according to an embodiment of the present disclosure;

FIG. 7 depicts a cloud computing environment according to an embodiment of the present disclosure; and

FIG. 8 depicts abstraction model layers according to an embodiment of the present disclosure.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A Complaint To Loss (CTL) ratio is an analytic measure of customer satisfaction that can be obtained using computer-based metrics that are available from a computer system. Organizations routinely report metrics for the number of customer complaints, the number of customers gained and lost, as well as the total number of customers for any given reporting period. Organizations also quote metrics such as, “Air Carrier X received less than 1 complaint per 1,000 passengers in January 2012”. The CTL ratio thus relies on metrics that are (in many cases) already being measured while still providing an effective insight into customer satisfaction.

Measuring customer satisfaction on an ongoing basis is an important indicator of success for many organizations. There are many measures and techniques available to measure customer satisfaction, although a significant number of them rely on some kind of customer survey being taken on a regular basis. The method presented in the present invention has a significant advantage over many conventional techniques because it does not rely upon surveys or sample data of any kind Rather, the present invention utilizes a CTL ratio that considers the entire customer base of an organization without requiring the customers to do anything more than their normal interactions with the enterprise.

For many organizations, customer satisfaction is measured via a survey. Results have shown that sometimes even when the survey techniques show that customer satisfaction is high customer retention rates can still be very low. There is also some evidence that the reverse is also true, meaning that there are other examples where customer satisfaction is low although customer retention is still high.

Furthermore, constrictive issues that arise when relying solely upon sampling or survey based techniques include: the size of the sample or survey, the timing of the sample or survey, and various biases in the sample group reflecting how good of an indicator the sample is of the entire population of customers. The percentage of customers that complain about an issue or participate in a survey can be a small (but vocal) sample of the customer base. These small (but vocal) sample groups may not necessarily represent the majority of an organization's customers.

The CTL ratio utilized herein is new and useful since it is based upon all customers, not just a sample. The two component metrics of the CTL ratio presented herein are 1) the number of customers that complain, and 2) the number of customers that are lost. Again, both metrics consider the entire customer population, not just a sample. In addition the CTL ratio has the advantage of taking into account the fact that even if customers are not complaining, this does not necessarily imply that they are happy. In addition, a CTL ratio cannot be manipulated by practices such as taking the survey right after a positive interaction such as purchasing a new product or getting a discount. Customers that say nothing but cease being customers are considered in this metric.

Just because a large percentage of customers are not complaining does not necessarily mean that they are satisfied with the service provided by an enterprise. Thus, the CTL ratio presented herein measures customer satisfaction across all customers based upon normal customer interaction with the corporation, as opposed to an artificial survey conducted on a sample of customers.

In one scenario, customer complaint rates are low but customer attrition rates (churn rates) are high. There are two ways to view this situation. The first is the optimistic mentality of believing that customers are not complaining because they are happy and not having problems. The second approach is the pessimistic approach of believing that customers are not complaining because they believe it will achieve nothing.

Consider now a company with a 1:100 CTL ratio, where for every 1 customer that has an issue or complains, 100 are lost. This indicates that customers are not complaining and their actions are showing that there are many viable alternatives. When the ratio is below 1:1 customers are not complaining, they are just leaving. Companies with a CTL of less than 1:1 need to prioritize customer retention strategies by adjusting products and/or services provided to their customers. For telecom operators examples of customer retention strategies are: offering unique services such as exclusive video and audio content, backup and recovery services, training and assisted upgrade services, global roaming, pooled data plans, Wi-Fi offload, as well as improving the in-store and on site customer premises experience.

Consider now a company with 100:1 CTL ratio, where for every 100 issues or complaints only 1 customer is lost. This can mean the product or service is very compelling, has few competitors or alternatives, customers are required to use the company/service because of employer policy or other requirement, or that customer complaints are actually suggestions for improvements and refinements to improve the offering. When the ratio is above 1:1, customers are complaining or commenting but they are not leaving. Companies with CTL ratios of more than 1:1 need to prioritize customer experience and satisfaction improvement strategies. Examples of customer experience improvement strategies are: meeting customer expectations, providing immediate value, shortening repair times, achieving on time meeting appointments, improving return policies, improving service availability, coverage and service quality (which for a telecom operator means increasing capacity and coverage), etc. Implied in this measure is the fact that a customer can only complain once in the monitoring period. Allowing (or counting) multiple complaints from the same customer during a given monitoring period will skew the CTL ratio.

Depending on the size of the enterprise for which CTL ratios are being utilized, a CTL ratio of 1:1 may have the same significance as the numerically equivalent CTL ratio of 10000:10000. To understand the ratio and what it implies, an initial perspective requires understanding that a CTL ratio of 0:0 is a “good” ratio, since it is based on no complaints and no customers leaving. The question of whether a CTL ratio of 1:10 is better than a CTL ratio of 2:10, if a CTL ratio of 10:1 is better than 20:1, is based on which ratio is closer to 0:0.

That is, a CTL ratio of 1:10 is better than a CTL ratio of 2:10, because it is closer to 0:0 when drawn on a graph. In addition since both 1:10 and 2:10 are CTL ratios that are below 1:1, this implies that an enterprise should prioritize customer retention strategies by optimizing their equipment and/or services. By this same logic a CTL ratio of 10:1 is “better” than a CTL ratio of 20:1 because it also is closer to 0:0, thus implying that there are fewer complaints for the same number of people leaving.

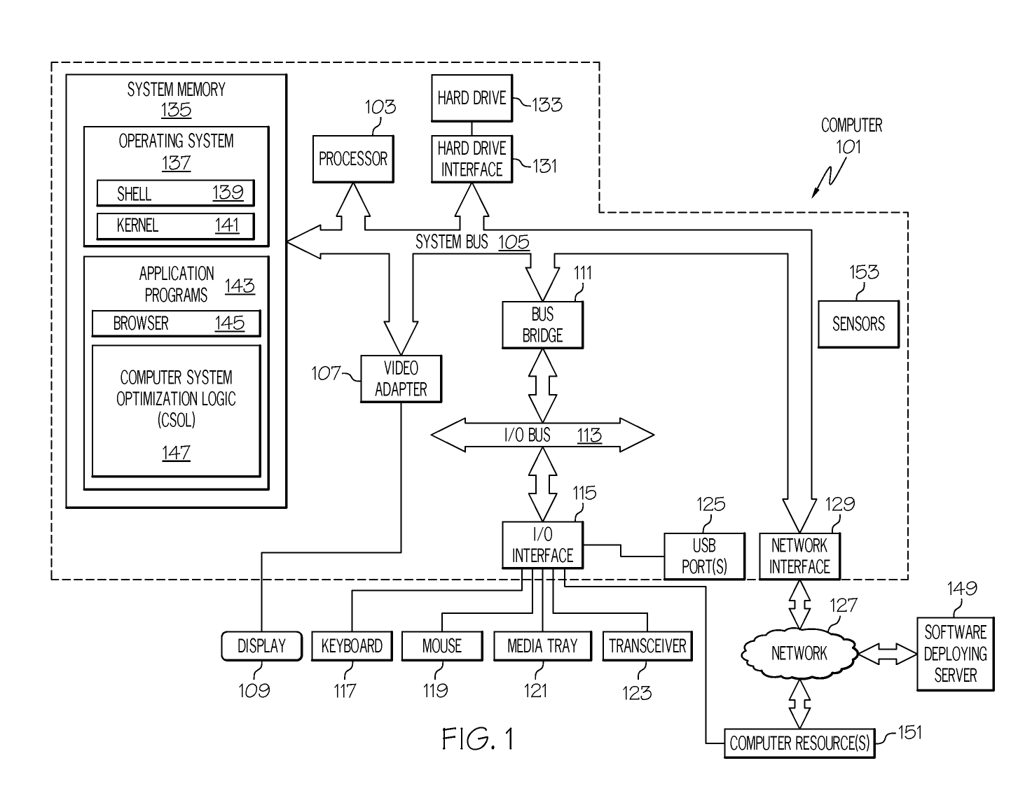

With reference now to the figures, and in particular to FIG. 1, there is depicted a block diagram of an exemplary system and network that may be utilized by and/or in the implementation of the present invention. Some or all of the exemplary architecture, including both depicted hardware and software, shown for and within computer 101 may be utilized by software deploying server 149 and/or computer resource(s) 151 shown in FIG. 1.

Exemplary computer 101 includes a processor 103 that is coupled to a system bus 105. Processor 103 may utilize one or more processors, each of which has one or more processor cores. A video adapter 107, which drives/supports a display 109, is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a mouse 119, a media tray 121 (which may include storage devices such as CD-ROM drives, multi-media interfaces, etc.), a transceiver 123 (capable of transmitting and/or receiving electronic communication signals), and external USB port(s) 125. While the format of the ports connected to I/O interface 115 may be any known to those skilled in the art of computer architecture, in one embodiment some or all of these ports are universal serial bus (USB) ports.

As depicted, computer 101 is able to communicate with a software deploying server 149 and/or other devices/systems (e.g., computer resource(s) 151) using a network interface 129. Network interface 129 is a hardware network interface, such as a network interface card (NIC), etc. Network 127 may be an external network such as the Internet, or an internal network such as an Ethernet or a virtual private network (VPN). In one or more embodiments, network 127 is a wireless network, such as a Wi-Fi network, a cellular network, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101′s operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging, thus enabling communication with software deploying server 149 and other systems.

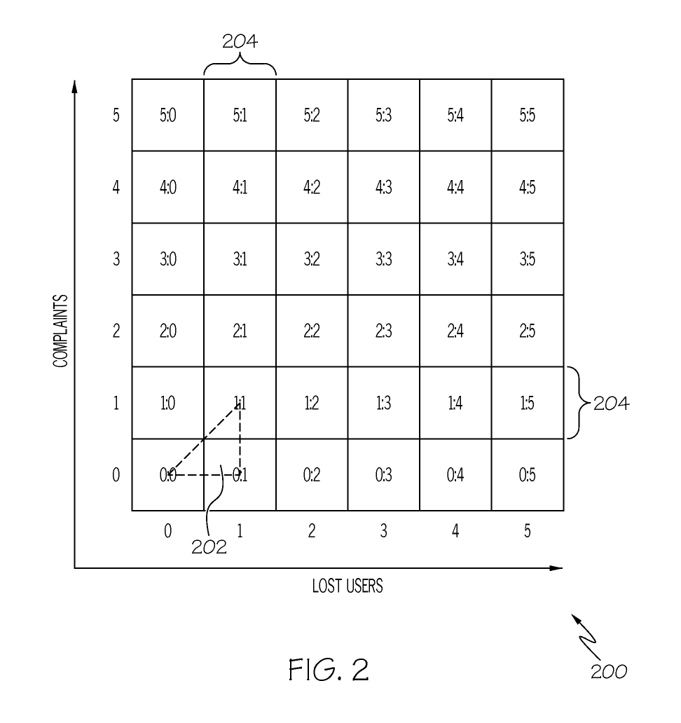

Application programs 143 in computer 101's system memory (as well as software deploying server 149's system memory) also include Computer System Optimization Logic (CSOL) 147. CSOL 147 includes code for implementing the processes described below, including those described in FIGS. 2-5. In one embodiment, computer 101 is able to download CSOL 147 from software deploying server 149, including in an on-demand basis, wherein the code in CSOL 147 is not downloaded until needed for execution. In one embodiment of the present invention, software deploying server 149 performs all of the functions associated with the present invention (including execution of CSOL 147), thus freeing computer 101 from having to use its own internal computing resources to execute CSOL 147.

Also associated with computer 101 are sensors 153, which detect usage of hardware components within computer 101 (e.g., processor 103, hard drive 133, etc.) and/or outside of computer 101 (e.g., computer resources 151). Thus, sensors 153 provide metrics that describe the usage or non-usage of various hardware devices.

Exemplary computer resources 151 include, but are not limited to, processors, storage devices, routers, modems, Internet access points (e.g., Wi-Fi access points), video cameras (e.g., security surveillance cameras), and other hardware devices that are used directly by computer 101 and/or indirectly by a user via computer 101. That is, computer resources 151 may be computer resources that are used directly by the computer 101 in order to allow the computer 101 to function properly (e.g., processor 103), or computer resources 151 may be resources that a user wishes to access through the computer 101 (e.g., a web server).

The hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

With reference now to FIG. 2, an exemplary two-dimensional Cartesian graph 200 of complaint to loss (CTL) records regarding use of a computer system is presented.

As shown in FIG. 2, graph 200 is a two dimensional Cartesian graph having a first axis (X-axis) that depicts the quantity of lost users of a computer system and a second axis that depicts the quantity of complaints about the computer system. That is, the X-axis depicts how many original users are no longer using the computer system, and the Y-axis depicts how many of the original users have complained about the computer system.

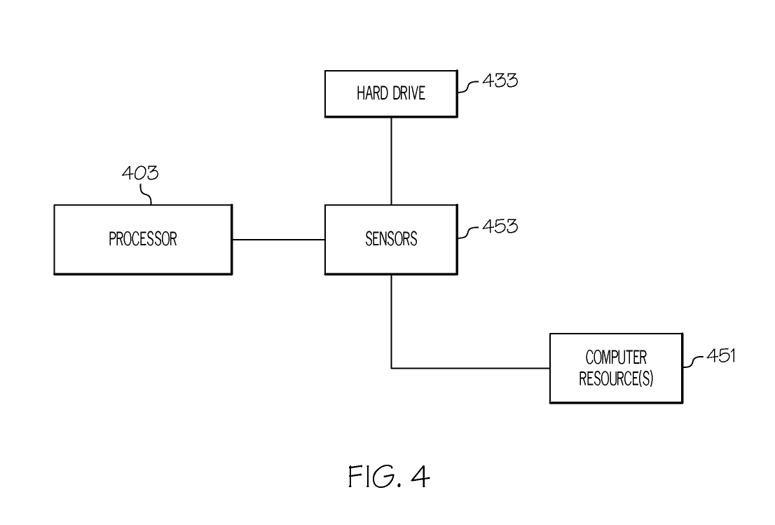

In one embodiment, complaints about the computer system (depicted on the Y-axis of graph 200) are user-generated. That is, in one embodiment, the complaints are in the form of calls to a customer service center, responses to a satisfaction questionnaire, comments on social media websites, etc. However, in a preferred embodiment, the complaints are not actual verbal or written complaints by users, but rather are interpreted sensor readings. For example, consider FIG. 4, which depicts sensors 453 (analogous to one or more of sensors 153 shown in FIG. 1) monitoring usage of resources within a computer system (e.g., processor 403 and hard drive 433, respectively analogous to processor 103 and hard drive 133 shown in FIG. 1), and/or external to the computer system (e.g., computer resource(s) 451, analogous to computer resource(s) 151 shown in FIG. 1).

For example, sensors 453 may include probes that measure how many instructions are being executed per second by hardware execution units (e.g., a Floating Point Unit—FPU) within a processor core (not depicted) of the processor 403. Similarly, sensors 453 may include probes that measure how many page swaps (e.g., pages of data being loaded into local memory) are required from hard drive 433. Similarly, sensors 453 may include probes that measure the amount of time required to access a remote data storage system (i.e., computer resource(s) 451). Thus, it is readings from the sensors 453 themselves that constitute a complaint. That is, the sensors 453 generate messages that describe a predefined deficiency in the computer system (e.g., FPUs executing instructions at a rate that is below some predefined rate, page swaps are occurring at a rate beyond some predefined limit, access to remote storage is taking longer than a predetermined time limit, etc.). These messages are received by a processor (e.g., processor 103 in FIG. 1), which then generates the complaints about the computer system directly from the messages describing the predefined deficiency in the computer system. Thus, the metrics from the sensors describe the predefined deficiency in the computer system, and occurrences of the predefined deficiency are interpreted as the complaints.

In one embodiment of the present invention, tracking how many customers leave within a certain time period identifies the quantity of lost users. However, in another embodiment, a drop in computer system usage infers lost users. That is, if a computer system is being accessed by an average of 100 users initially, but only 60 users a year later, then an inference is made that 40 users are no longer using this computer system.

Similarly, a drop in usage of subcomponents and/or associated resources of a computer system can be used to infer the drop in users. For example, assume that the computer resource(s) 151 shown in FIG. 1 is a server that provides on-line movies, which can be accessed for a fee. Furthermore, computer 101 serves a webpage that contains free on-line information about actors that is of interest to fans of the actors. Assume further that initially 1000 users access computer 101 daily, and 100 customers access the on-line movie server (computer resource(s) 151) daily. However, a year later, 1000 users still access computer 101 daily, but only 70 customers access the on-line movie server (computer resource(s) 151). This scenario also indicates a loss of customers, since it is the users of the on-line movie server (computer resource(s) 151), not the webpage provided by computer 101.

Thus, in this embodiment, one or more processors monitor usage of the computer system by members of the set of original users during a predetermined period of time. Based on the monitored usage of the computer system, a quantity of active users who use the computer system during the predetermined period of time is determined. This information allows the processors to determine/calculate the quantity of lost users as being a quantitative difference between the set of original users (e.g., 100 initial users of the computer resource(s) 151) and the quantity of active users (e.g., 70 later users of the computer resource(s) 151).

In one embodiment of the present invention, the determination of how many customers/users are lost is derived by assigning/associating particular computer resources to different customers/users. For example, assume that computer 101 in FIG. 1 provides access to 100 blade servers (computer resource(s) 151), and that each of the blade servers is reserved for the use of a specific customer. Thus, if 100 blade servers are in operation and being currently used, then there are 100 active customers. However, if 30 of the blade servers have not been used in the past three months, then an assumption can be made that there are only 70 active customers, and 30 customers have left.

Thus, in this embodiment, one or more processors associate each of the computer resources to a particular set of original users of the computer system. The processor(s) then monitor usage of each of the computer resources, in order to identify any computer resources that have not been used during the predetermined period of time. Based on this monitoring, the processor(s) are able to determine/calculate the quantity of lost users as being a quantity of computer resources that have not been used during the predetermined period of time (in the example above, 30).

Returning now to FIG. 2, graph 200 is used to determine which CTL ratios are indicative of a problem through the use of Cartesian distances. A first assumption is that more complaints are worse than fewer complaints about a computer system, and that more lost users of the computer system are worse than fewer lost users of the computer system, as discussed above. The graph 200 in FIG. 2 provides an additional analysis by identifying what types of problems are occurring, in order to identify solutions to these types of problems.

Specifically and as discussed above, if there are few lost users but many complaints about a computer system, then an assumption is drawn that even though there are technical problems with the computer system, users remain loyal to the computer system (for price point reasons, legacy reasons, etc.). However, this still indicates a need to correct the problems in the computer system, as identified by the sensors 453 shown in FIG. 4.

Similarly, if there are few complaints but many customers are leaving, then an assumption is drawn that the computer system is unable to recognize problems being suffered by the customers. That is, an assumption is raised that sensors 453 shown in FIG. 4 are unable to identify deficiencies in the computer system.

Graph 200 provides a two-dimensional solution to identifying which issue is prevalent: 1) poor overall performance that is readily apparent (due to customer complaints or reports from sensors), or 2) poor system feedback (due to a dearth of customer complaints or deficiencies in sensors in reporting problems).

As shown in FIG. 2, an optimal situation is for there to be no complaints (either lodged by the customers or detected by the sensors) and no lost users (i.e., customers/persons who have quit using the computer system), as indicated by the CTL ratio of 0:0. A next best situation is for there to be one complaint and no lost users, or one lost user and no complaints. The next best situation thereafter is for there to be one complaint and one lost user. As shown in the triangle 202, the graphical distance from the depicted CTL ratio 0:0 to 1:0 or 0:1 is less than the graphical distance from the depicted CTL ratio 0:0 to 1:1. Thus, these graphical distance differences indicate that the CTL ratio of 1:1 is worse than the CTL ratio of 1:0 or 0:1. If a predetermined ratio (e.g., 1:0 or 0:1) has been set as the upper limit of CTL ratios that are acceptable based on their graphical distance to CTL ratio 0:0, then the CTL ratio of 1:1 is deemed to exceed these limits, since the hypotenuse of triangle 202 is longer that the adjacent side from CTL 0:0 to CTL 0:1 (and similarly from CTL 0:0 to CTL 1:0, if a right-side triangle were to be drawn that included CTL 0:0 and CTL 1:0 as vertexes).

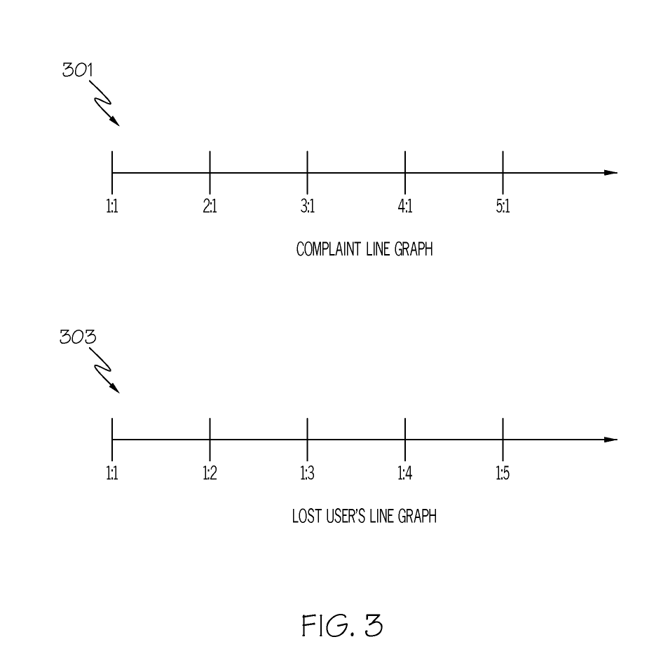

With reference now to FIG. 3, alternative one-dimensional CTL-based graphs of complaints and loss of users of a computer system are presented.

For example, consider a complaint line graph 301, which only shows CTL ratios from column 204 in graph 200 shown in FIG. 2 that are focused on how many complaints occur related to a computer system. Assume that a CTL ratio of 1:1 (one complaint for every one lost customer/user) is deemed acceptable (i.e., is a predefined value/limit), then any larger CTL ratio (e.g., 2:1 or above) is deemed unacceptable, and triggers an upgrade/optimization of the architecture, resources, etc. of the computer system. Thus, complaint line graph 301 is a one-dimensional line, and the CTL ratio falling outside of the predefined graphical distance is a rational number greater than the predefined limit of 1.0 (i.e., the ratio of 1:1).

Consider now the lost user's line graph 303, which only shows CTL ratios from row 206 in graph 200 shown in FIG. 2 that are focused on how many users stop using the computer system. Assume that a CTL ratio of 1:1 (one complaint for every one lost customer/user) is deemed acceptable (i.e., is a predefined value/limit), then any smaller CTL ratio (e.g., 1:2 or smaller) is deemed unacceptable, and triggers an upgrade/optimization of sensors in the computer system. Thus, complaint line graph 303 is a one-dimensional line, and the CTL ratio falling outside of the predefined graphical distance is a rational number less than the exemplary predefined limit of 1.0 (i.e., the ratio of 1:1).

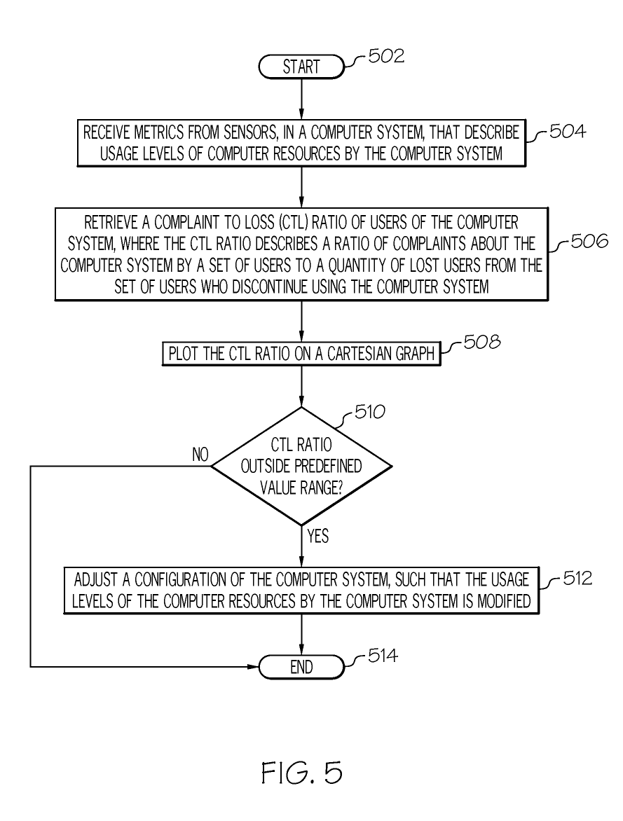

With reference now to FIG. 5, a high-level flow chart of one or more steps performed by one or more processors to optimize a computer system in accordance with one or more embodiments of the present invention is presented.

After initiator block 502, one or more processors (e.g., processor 103 in FIG. 1) receive(s) metrics from sensors (e.g., sensors 153 in FIG. 1) in a computer system (e.g., computer 101 in FIG. 1), as depicted in block 504. As described herein, these metrics describe usage levels of computer resources (within or outside of) the computer system. As described above, the computer system is initially used by a set of original users.

As described in block 506 of FIG. 5, the processor(s) retrieve a complaint to loss (CTL) ratio for the set of original users of the computer system. As described in detail above, the CTL ratio describes a ratio of a quantity of problems with the computer system that are experienced and reported as complaints by members of the set of original users to a quantity of lost users from the set of original users who discontinue use of the computer system.

As described in block 508 of FIG. 5, the processors(s) then plot the retrieved CTL ratio on a graph (e.g., the Cartesian graph 200 shown in FIG. 2 and/or the line graphs 301/303 shown in FIG. 3).

As depicted in query block 510, a query is made as to whether the CTL ratio falls outside of a predefined graphical distance from a 0:0 CTL ratio plotted on the graph, as described above. If so, then the processor(s) adjust a configuration of the computer system, as described in block 512. This adjustment, which may be made to used resources and/or to monitoring sensors (as described above), optimizes the computer system by optimizing the usage levels of the computer resources by the computer system, either by adjusting the computer resources themselves (in the case of a high CTL ratio, such as more than 1.0), or by adjusting the sensors that monitor the computer system (in the case of a low CTL ratio, such as being less than 1.0).

The flow-chart ends at terminator block 514.

In one or more embodiments, the present invention is implemented in a cloud environment. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

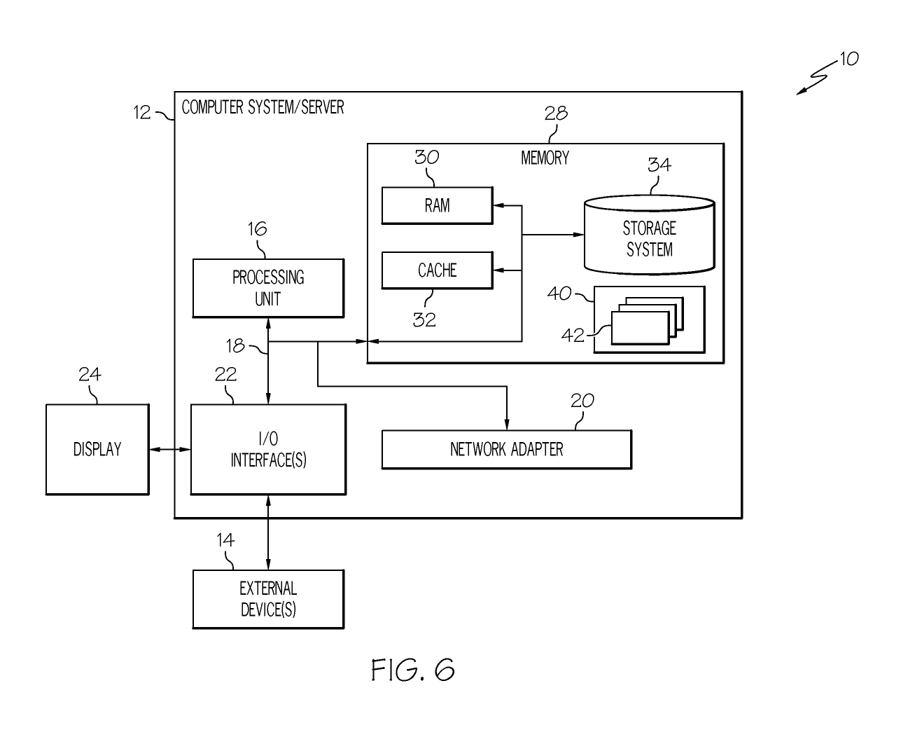

Referring now to FIG. 6, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

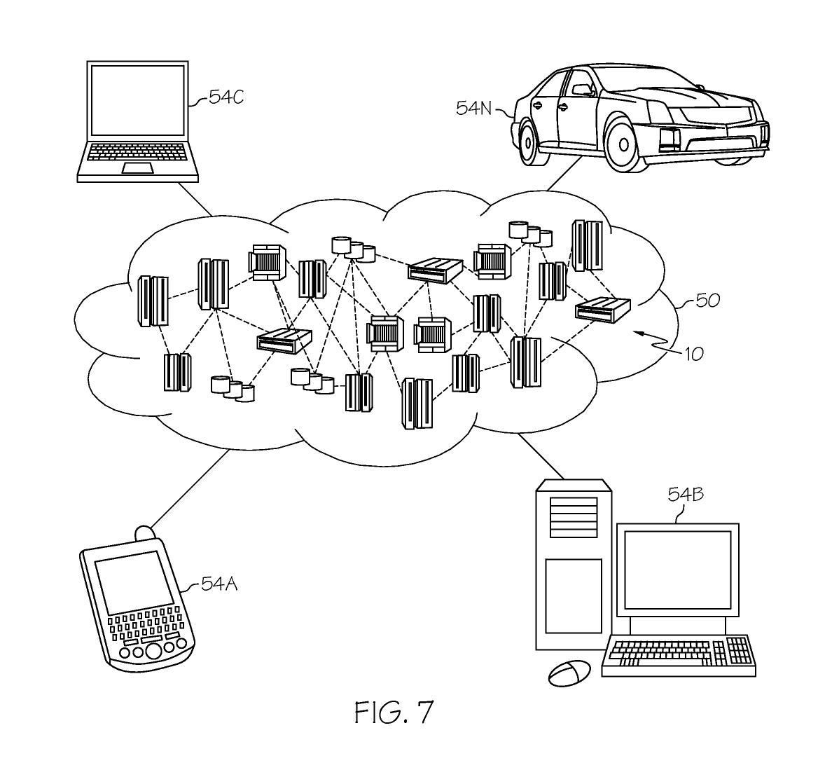

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone MA, desktop computer MB, laptop computer MC, and/or automobile computer system MN may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 7 are intended to be illustrative only and that computing nodes 10 and cloud computing environment 50 can communicate with any type of computerized device over any type of network and/or network addressable connection (e.g., using a web browser).

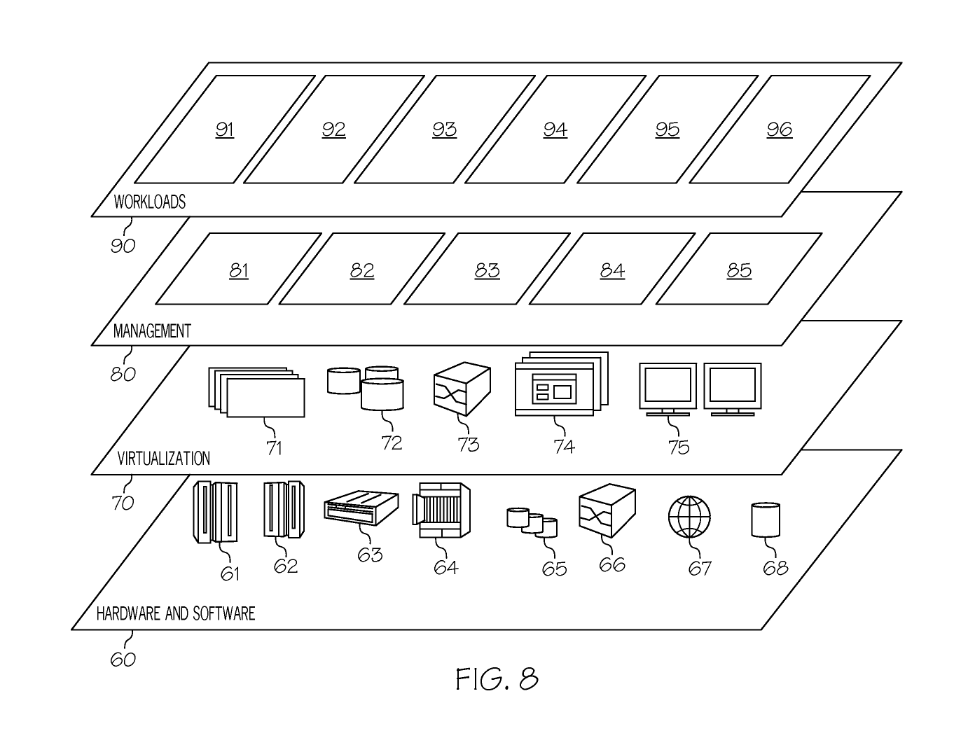

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and computer system optimization processing 96 (for optimizing a computer system as described herein).

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A computer-implemented method for optimizing a computer system, the computer-implemented method comprising:
receiving, by one or more processors, metrics from sensors in a computer system, wherein the metrics describe usage levels of computer resources by the computer system, and wherein the computer system is used by a set of original users;
retrieving, by one or more processors, a complaint to loss (CTL) ratio for the set of original users of the computer system, wherein the CTL ratio describes a ratio of a quantity of problems with the computer system that are experienced and reported as a quantity of complaints by members of the set of original users to a quantity of lost users from the set of original users who discontinue use of the computer system;
plotting, by one or more processors, the CTL ratio on a graph; and
in response to the CTL ratio falling outside of a predefined graphical distance from a 0:0 CTL ratio plotted on the graph, adjusting, by one or more processors, a configuration of the computer system, wherein adjusting the configuration of the computer system optimizes the computer system by modifying the usage levels of the computer resources by the computer system.

2. The computer-implemented method of claim 1, further comprising:
receiving, from the sensors, messages describing a predefined deficiency in the computer system; and
generating, by one or more processors, the complaints about the computer system directly from the messages describing the predefined deficiency in the computer system, wherein the metrics from the sensors describe the predefined deficiency in the computer system, and wherein occurrences of the predefined deficiency are interpreted as the complaints.

3. The computer-implemented method of claim 2, further comprising:
monitoring, by one or more processors, usage of the computer system by members of the set of original users during a predetermined period of time;
determining, by one or more processors and based on the monitored usage of the computer system, a quantity of active users who use the computer system during the predetermined period of time; and
determining, by the one or more processors, the quantity of lost users as being a quantitative difference between the set of original users and the quantity of active users.

4. The computer-implemented method of claim 2, further comprising:
associating, by one or more processors, each of the computer resources to a particular set of original users of the computer system;
monitoring, by one or more processors, usage of each of the computer resources;
identifying, by one or more processors, computer resources that have not been used during a predetermined period of time; and
determining, by one or more processors, the quantity of lost users as being a quantity of computer resources that have not been used during the predetermined period of time.

5. The computer-implemented method of claim 1, wherein the graph is a two dimensional Cartesian graph comprising a first axis that depicts the quantity of lost users of the computer system and a second axis that depicts the quantity of complaints about the computer system in the CTL ratio.

6. The computer-implemented method of claim 1, wherein the graph is a one dimensional line, and wherein the CTL ratio falling outside of the predefined graphical distance is a rational number greater than a predefined limit.

7. The computer-implemented method of claim 1, wherein the graph is a one dimensional line, and wherein the CTL ratio falling outside of the predefined graphical distance is a rational number less than a predefined limit.

8. A computer program product for optimizing a computer system, the computer program product comprising a non-transitory computer readable storage medium having program code embodied therewith, the program code readable and executable by a processor to perform a method comprising:
receiving metrics from sensors in a computer system, wherein the metrics describe usage levels of computer resources by the computer system, and wherein the computer system is used by a set of original users;
retrieving a complaint to loss (CTL) ratio for the set of original users of the computer system, wherein the CTL ratio describes a ratio of a quantity of problems with the computer system that are experienced and reported as a quantity of complaints by members of the set of original users to a quantity of lost users from the set of original users who discontinue use of the computer system;
plotting the CTL ratio on a graph; and
in response to the CTL ratio falling outside of a predefined graphical distance from a 0:0 CTL ratio plotted on the graph, adjusting a configuration of the computer system, wherein adjusting the configuration of the computer system optimizes the computer system by modifying the usage levels of the computer resources by the computer system.

9. The computer program product of claim 8, wherein the method further comprises:
receiving, from the sensors, messages describing a predefined deficiency in the computer system;
generating the complaints about the computer system directly from the messages describing the predefined deficiency in the computer system, wherein the metrics from the sensors describe the predefined deficiency in the computer system, and wherein occurrences of the predefined deficiency are interpreted as the complaints.

10. The computer program product of claim 9, wherein the method further comprises:
monitoring usage of the computer system by members of the set of original users during a predetermined period of time;
determining, based on the monitored usage of the computer system, a quantity of active users who use the computer system during the predetermined period of time; and
determining the quantity of lost users as being a quantitative difference between the set of original users and the quantity of active users.

11. The computer program product of claim 9, wherein the method further comprises:
associating each of the computer resources to a particular set of original users of the computer system;
monitoring usage of each of the computer resources;
identifying computer resources that have not been used during a predetermined period of time; and
determining the quantity of lost users as being a quantity of computer resources that have not been used during the predetermined period of time.

12. The computer program product of claim 8, wherein the graph is a two dimensional Cartesian graph comprising a first axis that depicts the quantity of lost users of the computer system and a second axis that depicts the quantity of complaints about the computer system in the CTL ratio.

13. The computer program product of claim 8, wherein the graph is a one dimensional line, and wherein the CTL ratio falling outside of the predefined graphical distance is a rational number greater than a predefined limit.

14. The computer program product of claim 8, wherein the graph is a one dimensional line, and wherein the CTL ratio falling outside of the predefined graphical distance is a rational number less than a predefined limit.

15. A computer system comprising:
a processor, a computer readable memory, and a non-transitory computer readable storage medium;
first program instructions to receive metrics from sensors in a computer system, wherein the metrics describe usage levels of computer resources by the computer system, and wherein the computer system is used by a set of original users;
second program instructions to retrieve a complaint to loss (CTL) ratio for the set of original users of the computer system, wherein the CTL ratio describes a ratio of a quantity of problems with the computer system that are experienced and reported as a quantity of complaints by members of the set of original users to a quantity of lost users from the set of original users who discontinue use of the computer system;
third program instructions to plot the CTL ratio on a graph; and
fourth program instructions to, in response to the CTL ratio falling outside of a predefined graphical distance from a 0:0 CTL ratio plotted on the graph, adjust a configuration of the computer system, wherein adjusting the configuration of the computer system optimizes the computer system by modifying the usage levels of the computer resources by the computer system; and wherein
the first, second, third, and fourth program instructions are stored on the non-transitory computer readable storage medium for execution by one or more processors via the computer readable memory.

16. The computer system of claim 15, further comprising:
fifth program instructions to receive, from the sensors, messages describing a predefined deficiency in the computer system; and
sixth program instructions to generate the complaints about the computer system directly from the messages describing the predefined deficiency in the computer system, wherein the metrics from the sensors describe the predefined deficiency in the computer system, and wherein occurrences of the predefined deficiency are interpreted as the complaints; and wherein the fifth and sixth program instructions are stored on the non-transitory computer readable storage medium for execution by one or more processors via the computer readable memory.

17. The computer system of claim 16, further comprising:
fifth program instructions to monitor usage of the computer system by members of the set of original users during a predetermined period of time;
sixth program instructions to determine, based on the monitored usage of the computer system, a quantity of active users who use the computer system during the predetermined period of time; and
seventh program instructions to determine the quantity of lost users as being a quantitative difference between the set of original users and the quantity of active users; and
wherein
the fifth, sixth, and seventh program instructions are stored on the non-transitory computer readable storage medium for execution by one or more processors via the computer readable memory.

18. The computer system of claim 16, further comprising:
fifth program instructions to associate each of the computer resources to a particular set of original users of the computer system;
sixth program instructions to monitor usage of each of the computer resources;
seventh program instructions to identify computer resources that have not been used during a predetermined period of time; and
eighth program instructions to determine the quantity of lost users as being a quantity of computer resources that have not been used during the predetermined period of time; and
wherein
the fifth, sixth, seventh, and eighth program instructions are stored on the non-transitory computer readable storage medium for execution by one or more processors via the computer readable memory.

19. The computer system of claim 15, wherein the graph is a two dimensional Cartesian graph comprising a first axis that depicts the quantity of lost users of the computer system and a second axis that depicts the quantity of complaints about the computer system in the CTL ratio

20. The computer system of claim 15, wherein the graph is a one dimensional line, and wherein the CTL ratio falling outside of the predefined graphical distance is a rational number greater than a predefined limit.
